(19) United States
(12) Patent Application Publication
(10) Pub. No.: US 2020/0104788 A1
(43) Pub. Date: Apr. 2, 2020

(54) FOOD EXPIRATION REPORTING AND INTELLIGENCE TRACKING

(71) Applicant: TransAct Technologies Incorporated, Hamden, CT (US)

(72) Inventors: Bart C. Shuldman, Westport, CT (US); David L. Block, El Cerrito, CA (US)

(21) Appl. No.: 16/572,829

(22) Filed: Sep. 17, 2019

Related U.S. Application Data
(60) Provisional application No. 62/737,305, filed on Sep. 27, 2018.

(51) Int. Cl. G06Q 10/08; G06Q 50/12

(52) U.S. Cl. CPC G06Q 10/087; G06Q 50/12

(57) ABSTRACT

Methods and apparatus for food expiration reporting and intelligent inventory tracking is provided. A food item inventory database is created listing at least food item name, quantity, and expiration date. It is then determined, via a computer processor associated with the food item inventory database, whether any of the food items have an expiration date falling within at least one future predetermined time period in order to identify expiring food items. An alert can then be generated at a user interface indicating that one or more of the food items have an expiration date falling within the at least one future predetermined time period. Based on this information, menu items can be adjusted, menu specials can be implemented, and intelligent inventory management can be facilitated.

This application claims the benefit of commonly owned U.S. provisional application No. 62/737,305 filed on Sep. 27, 2018, which is incorporated herein and made a part hereof by reference

### BACKGROUND OF THE INVENTION

The present invention relates to the food services field. More specifically, the present invention relates to leveraging data stored in food services databases and printers to provide reports and analysis relating to expiring food inventory.

Restaurants are required to keep track of perishable food products and ingredients. Using a pre-configured database containing information pertaining to each food item, a label is printed and placed on the packaging of the food item. The label may contain the date and time of the label printing (when received, or when a sealed/stored product is first put to use), the item/ingredient name, an expiration or “use by” date for the item (often containing the date, day of week, and time of expiration). Along with this, other supporting information such as the name of the user printing the label, may be included. In addition, a barcoded version of the expiration date may be printed.

The data entered into the database for each item may include the item/ingredient name, quantity, date received, expiration date or time, and specific text to be printed, such as “Expires on ______:” or “Discard After: ______” Translations of the information may be provided if bi-lingual labels or alternative labels are required to ensure food safety. In the case where the system is also printing nutritional information or other types of labels, the nutritional information required for FDA labeling and, for some items, a list of particular ingredients or allergens for the food product that would be included in labels may be entered into the database and printed on the labels for the consumer of the food item or package of food items.

Label printers are provided in the food preparation/storage area of a restaurant and are used to create “freshness labels” for each package of food or ingredients. As indicated above, these label printers may also print non-freshness labels (e.g., ingredient or nutritional labels) for some of these same items. The label may indicate all or a subset of the data entered in the database, and at a minimum include the item name, and expiration date (including time of day, end of day, or an expiration time calculated based on when the food packaging was initially opened). For example, some foods may require exactly 2 days for the expiration date, in which case a food item that was labeled at 1:42 pm on a Monday, would expire at 1:42 pm on Wednesday.

A menu database may be created identifying the food items used by a restaurant. The menu database may include classes or groups of menu items (e.g., sandwiches, salads, proteins, carbohydrates, drinks, etc.). The ingredients (food items) for each menu item are associated with the menu items in the database. The menu database or portions of the data contained in the menu database may be downloaded to the printer terminal along with parameters for label size, label format, expiration dates (or freshness periods), and the like.

In the case of “fresh” items such as fresh meat, produce, fruit, dairy products and the like, the expiration date will be set at the time of initial intake of the food item into the system and certain foods will have different expiration dates. For example, lettuce may be given an expiration date 5 days after delivery. Some foods may be treated differently, and have more than one applicable date based on either the type of food or whether and when the packaging is opened. In these cases, the system may be programmed to treat the earliest of the possible dates as the expiration date. For example, chicken must be used within a certain number of days from the “kill date” (the date the chicken was butchered), which is indicated on the packaging and prompted for when a label is being printed or when the food item is accepted into inventory. However, the restaurant may require any chicken to be used within 4 days of delivery. Thus, the system will log the earlier of the kill date or the 4 days from date of delivery as the expiration date.

Some items can be stored in a freezer or cooler, or even on a shelf, for a limited time even if unopened. In this case, a freshness label will be printed and applied to the item packaging when the item is first received at the facility, indicating an expiration date for the unopened package. As the expiration date may change once such a package is opened, and upon opening of the package a second freshness label will be printed indicating a new expiration date.

It would be advantageous to leverage this existing data to automatically and intelligently generate alerts and reports identifying expiring food items, track and limit food item waste, and facilitate inventory management.

The methods and apparatus of the present invention provide the foregoing and other advantages.

### SUMMARY OF THE INVENTION

The present invention relates to leveraging data stored in food services databases and printers to provide reports and analysis relating to expiring food inventory, including for example food expiration reporting, inventory tracking, and inventory management.

In one example embodiment of the present invention, a computerized method for food expiration reporting and intelligent inventory tracking is provided. In accordance with the method, a food item inventory database is created which comprises a listing of at least food item name, quantity, and expiration date. It is then determined, via a computer processor associated with the food item inventory database, whether any of the food items have an expiration date falling within at least one future predetermined time period in order to identify expiring food items. An alert can then be generated at a user interface indicating that one or more of the food items have an expiration date falling within the at least one future predetermined time period.

The method may also enable, via the user interface, display or printing of a report listing the identified expiring food items.

The at least one future predetermined time period may comprise multiple future predetermined time periods. The multiple future predetermined time periods may comprise at least one of different predetermined time periods and overlapping time periods. The at least one future predetermined time period may be at least one of preset or customizable.

The method may further comprise creating a menu database comprising menu items and corresponding food item ingredients, identifying, via the computer processor, the menu items which contain one or more of the identified expiring food items as at least one of the corresponding food item ingredients, and enabling, via the user interface, display or printing of a listing of the menu items which contain one or more of the expiring food items.

Menu specials may be determined based on the listing of menu items. Substitute ingredients for the identified expiring food items may be determined for each of the menu items in the listing of menu items.

In a further example embodiment of the present invention, the method may also comprise tracking food item usage and the identified expiring food items which have expired, determining food item inventory need predictions based on the food item usage and the expired food items, and adjusting one of an amount and timing of inventory ordering based on the food item inventory need predictions.

The inventory needs predictions may be used to accommodate the food item inventory needs for at least one of weekdays, weekends, weeks, months, seasons of the year, holidays, scheduled events, or the like.

The present invention may also enable automatic reordering of food items based on the food item inventory need predictions.

A label printer may be in communication with the processor, the user interface, and the food item inventory database. Labels may be printed from the label printer for any menu items that are created or sold. The quantity of the food item in the food item inventory database may be adjusted to account for the food items or portions of the food items included within the menu items set forth on the labels.

The expiring food items may be analyzed to at least one of implement menu item specials including at least one of the expiring food items, adjust required inventory levels, adjust inventory ordering parameters, track expiring food item usage over time, and the like.

The present invention also encompasses a computerized system for food expiration reporting and intelligent inventory tracking. The system may comprise: a food item inventory database listing at least food item name, quantity, and expiration date; a computer processor associated with the food item inventory database for determining whether any of the food items have an expiration date falling within at least one future predetermined time period in order to identify expiring food items; and a user interface adapted to generate an alert indicating that one or more of the food items have an expiration date falling within the at least one future predetermined time period.

The system may also include additional features and functionality as discussed above in connection with the various method embodiments.

### BRIEF DESCRIPTION OF THE DRAWINGS

The present invention will hereinafter be described in conjunction with the appended drawing FIGURE:

FIG. 1 shows a block diagram of an example embodiment of a system in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The present invention leverages existing food industry data, such as that found in a restaurant database, or data loaded into a food services printer such as a food services label printer. In accordance with the present invention, this data can be leveraged in a number of ways, including by generating alerts and reports relating to expiring food, by enabling food expiration and food waste tracking, and by facilitating inventory management.

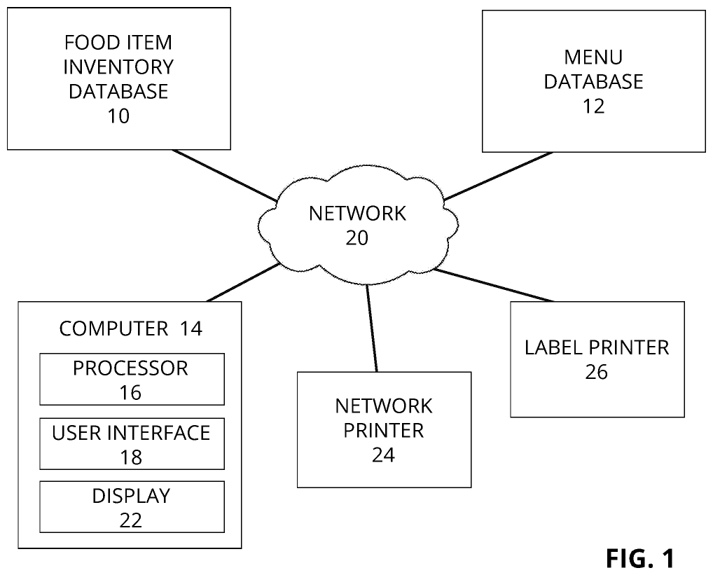

FIG. 1 shows a block system diagram of an exemplary embodiment of a computerized system for food expiration reporting and intelligent inventory tracking in accordance with the present invention. A food item inventory database 10 is created which comprises a listing of at least food item name, quantity, and expiration date for a plurality of food items. Additional information for each food item may be entered into the database 10, including date received, “use by” date, “sell by” date, kill date for meat items, freshness date, shelf life, expiration period after package opening, name of user entering data, or other specific data that may be associated with a food item for printing on a label.

A computer 14 comprising a computer processor 16 may be associated with the food item inventory database 10 for determining whether any of the food items have an expiration date falling within at least one future predetermined time period, in order to identify expiring food items. The computer 14 may be connected to the food item inventory database 10 via a wired or wireless network 20, such as for example the Internet, a Wi-Fi network, a local area network, a wide area network, a cellular network, or the like.

A user interface 18 of the computer 14 may be adapted to generate an alert indicating that one or more of the food items have an expiration date falling within the at least one future predetermined time period. In response to the alert, the user may then, via the user interface 18, generate a report listing the identified food items that are about to expire. The report may be presented on a display (e.g., on a display 22 of the computer 14) and/or printed (e.g., at a network printer 24 or label printer 26).

The at least one future predetermined time period may comprise multiple future predetermined time periods. The multiple future predetermined time periods may comprise at least one of different predetermined time periods and overlapping time periods. The at least one future predetermined time period may be at least one of preset or customizable. For example, the alert and reports can be customizable to indicate food items that are expiring within any period, such as within the next day, the next two days, the next week, or the like. The time period can be preset or programmable. The system can be programmed to generate a report listing expiring food items over several time periods. For example, the report may indicate food items expiring each day of the coming week, or over any desired period or periods.

The expiring food items may be analyzed (e.g., via the processor 16) to at least one of implement or recommend menu item specials including at least one of the expiring food items, adjust required inventory levels, adjust inventory ordering parameters, track expiring food item usage over time, and the like.

A menu database 12 may be created which comprises menu items and corresponding food item ingredients. The menu database 12 may be accessible by the computer 14 via the network 20. Using the menu database 12, the system can identify, via the computer processor 16, the menu items which contain one or more of the identified expiring food items as at least one of the corresponding food item ingredients. The user interface 18 may enable display or printing of a report listing the menu items which contain one or more of the expiring food items.

Menu specials may be determined based on the report of the menu items which contain one or more of the expiring food items. For example, the report can be used by the restaurant manager to determine whether it would be advantageous to run a special which includes an expiring food item. For example, if the report shows that a large amount of chicken will expire in the next two days, a special on chicken sandwiches can be run until the chicken is used or expires. Further, the system may generate a list of possible specials based on the expiring food items and the current or possible menu items, or even specify a recipe that might change the state of the item in order to extend the life of the item, such as using expiring chicken in chicken soup or baking the chicken for use in chicken sandwiches.

Additionally, substitute ingredients for the identified expiring food items may be determined for each of the menu items in the listing of menu items.

The system may enable the tracking of food item usage and what food items will be expiring over time, as well as the tracking of what food has expired. Food item inventory need predictions may be determined based on the food item usage and the expired food items. An amount and timing of inventory ordering may be adjusted based on the food item inventory need predictions. For example, tracking what food will expire over time (e.g., how much chicken expires tomorrow, how much expires in two days, how much expires in four days, etc.) may enable the restaurant manager to set the menu or determine a schedule for specials throughout the next week or month. Tracking how much food has expired and gone to waste will enable a manager (or the system in the event of automatic inventory management) to make inventory level adjustments (how much chicken is kept on hand) as well as adjust the timing of inventory ordering to reduce waste from food expiration.

The system may also enable intelligent tracking over time and provide inventory need predictions based on past usage and waste history. For example, the system may learn that there is more waste of a certain food item in the middle of a week than on the weekend, such that the food item ordering can be adjusted accordingly to avoid over purchasing. The system may use this information to suggest modifications to a weekly food item order. Such intelligence tracking may be used to accommodate for holidays, weekdays, weekends, weeks, months, temperature, seasons of the year, scheduled events (sporting events, concerts, and the like) in the area, and the like.

Data pertaining to the tracking of food item usage and expiration may be stored in a database (e.g., food item inventory database 10, data storage on computer 14, a separate database or hard drive, or the like) to facilitate inventory need predictions.

The system may enable automatic ordering or reordering of food items based on an analysis of food item usage, food item waste, and current menus or planned menu changes.

In addition, the food item inventory database 10 may include a “Lot number” for the item, to aid in recalling foods based on FDA or manufacturer alerts of such things as bacterial infection (E. coli), packaging issues (mis-labeled product, glass, etc.), or the like.

A label printer 26 may be in communication with the computer 14, the processor 16, the user interface 18, and the food item inventory database 10. Labels may be printed from the label printer 26 for any menu items that are created or sold. The quantity of the food item in the food item inventory database 10 may be adjusted to account for the food items or portions of the food items included within the menu items set forth on the labels.

The label printer 26 may also be used to print “Grab and Go” labels for sandwiches and other items (e.g., Yogurt parfait). As the system date codes and labels individual food items, it is able to track the quantity of each item. When a food item is used to create a grab and go item, the quantity of the item remaining can be reduced accordingly once a label is printed for the grab and go item. Thus, the expiring food item which is included in the grab and go item will be accounted for in an all-inclusive sell by date for the grab and go item, which sell by date takes into consideration the expiration dates of all individual items included therein. Alerts can be provided indicating grab and go items expiring within a certain time period.

Expiring items included in the grab and go items optionally may not be separately included in system alerts.

It should be appreciated that the FIG. 1 is an example schematic block diagram representation of one possible implementation of the present invention, and that the various hardware devices may be combined or discrete components. For example, the food item inventory database 10 and the menu database 12 may be partitions of a single database structure. Further, the databases 10, 12 may be maintained on one or more separate servers or on a hard drive or other non-volatile storage medium of the computer 14 or of the label printer 26. Similarly, the computer 14 may be integral to the label printer 26. Those skilled in the art should also appreciate that the computer 14 may take the form of a desktop computer, a laptop computer, a tablet computer, a personal computer, a smartphone, a smart watch, or the like.

It should now be appreciated that the present invention provides advantageous methods and apparatus for limiting food expiration waste and managing food item inventory.

Although the invention has been described in connection with various illustrated embodiments, numerous modifications and adaptations may be made thereto without departing from the spirit and scope of the invention as set forth in the claims.

What is claimed is:

1. A computerized method for food expiration reporting and intelligent inventory tracking, comprising:
creating a food item inventory database comprising a listing of at least food item name, quantity, and expiration date;
determining, via a computer processor associated with the food item inventory database, whether any of the food items have an expiration date falling within at least one future predetermined time period to identify expiring food items; and
generating an alert at a user interface indicating that one or more of the food items have an expiration date falling within the at least one future predetermined time period.

2. A computerized method in accordance with claim 1, further comprising:
enabling, via the user interface, display or printing of a report listing the identified expiring food items.

3. A computerized method in accordance with claim 1, wherein the at least one future predetermined time period comprises multiple future predetermined time periods.

4. A computerized method in accordance with claim 3, wherein the multiple future predetermined time periods comprise at least one of different predetermined time periods and overlapping time periods.

5. A computerized method in accordance with claim 1, wherein the at least one future predetermined time period is at least one of preset or customizable.

6. A computerized method in accordance with claim 1, further comprising:
creating a menu database comprising menu items and corresponding food item ingredients;
identifying, via the computer processor, the menu items which contain one or more of the identified expiring food items as at least one of the corresponding food item ingredients; and
enabling, via the user interface, display or printing of a listing of the menu items which contain one or more of the expiring food items.

7. A computerized method in accordance with claim 6, further comprising:
determining menu specials based on the listing of menu items.

8. A computerized method in accordance with claim 6, further comprising:
determining substitute ingredients for the identified expiring food items for each of the menu items in the listing of menu items.

9. A computerized method in accordance with claim 1, further comprising:
tracking food item usage and the identified expiring food items which have expired;
determining food item inventory need predictions based on the food item usage and the expired food items; and
adjusting one of an amount and timing of inventory ordering based on the food item inventory need predictions.

10. A computerized method in accordance with claim 9, wherein the inventory needs predictions are used to accommodate the food item inventory needs for at least one of weekdays, weekends, weeks, months, seasons of the year, holidays, and scheduled events.

11. A computerized method in accordance with claim 9, further comprising:
automatic reordering of food items based on the food item inventory need predictions.

12. A computerized method in accordance with claim 1, wherein:
a label printer is in communication with the processor, the user interface, and the food item inventory database;
labels are printed from the label printer for any menu items that are created or sold; and
the quantity of the food item in the food item inventory database is adjusted to account for the food items or portions of the food items included within the menu items set forth on the labels.

13. A computerized method in accordance with claim 1, further comprising:
analyzing the expiring food items to at least one of implement menu item specials including at least one of the expiring food items, adjust required inventory levels, adjust inventory ordering parameters, and track expiring food item usage over time.

14. A computerized system for food expiration reporting and intelligent inventory tracking, comprising:
a food item inventory database listing at least food item name, quantity, and expiration date;
a computer processor associated with the food item inventory database for determining whether any of the food items have an expiration date falling within at least one future predetermined time period to identify expiring food items; and
a user interface adapted to generate an alert indicating that one or more of the food items have an expiration date falling within the at least one future predetermined time period.

15. A computerized system in accordance with claim 14, wherein:
a report listing the identified expiring food items is displayed at the user interface or printed.

16. A computerized system in accordance with claim 14, wherein the at least one future predetermined time period comprises multiple future predetermined time periods.

17. A computerized system in accordance with claim 16, wherein the multiple future predetermined time periods comprise at least one of different predetermined time periods and overlapping time periods.

18. A computerized system in accordance with claim 14, wherein the at least one future predetermined time period is at least one of preset or customizable.

19. A computerized system in accordance with claim 14, further comprising a menu database comprising menu items and corresponding food item ingredients, wherein:
the computer processor identifies the menu items which contain one or more of the identified expiring food items as at least one of the corresponding food item ingredients; and
a report listing the menu items which contain one or more of the expiring food items is displayed at the user interface or printed.

20. A computerized system in accordance with claim 19, wherein the processor determines menu specials based on the listing of menu items.

21. A computerized system in accordance with claim 19, wherein the processor determines substitute ingredients for the identified expiring food items for each of the menu items in the listing of menu items.

22. A computerized system in accordance with claim 14, wherein:
food item usage is tracked;
the identified expiring food items which have expired are tracked;
determining food item inventory need predictions based on the food item usage and the expired food items; and
adjusting one of an amount and timing of inventory ordering based on the food item inventory need predictions.

23. A computerized system in accordance with claim 22, wherein the inventory needs predictions are used to accommodate the food item inventory needs for at least one of weekdays, weekends, weeks, months, seasons of the year, holidays, and scheduled events.

24. A computerized system in accordance with claim 22, wherein the processor enables automatic reordering of food items based on the food item inventory need predictions.

25. A computerized system in accordance with claim 14, further comprising:
a label printer in communication with the processor, the user interface, and the food item inventory database, wherein:
labels are printed from the label printer for any menu items that are created or sold; and
the quantity of the food item in the food item inventory database is adjusted to account for the food items or portions of the food items included within the menu items set forth on the labels.

26. A computerized system in accordance with claim 14, wherein the processor analyzes the expiring food items to at least one of implement menu item specials including at least one of the expiring food items, adjust required inventory levels, adjust inventory ordering parameters, and track expiring food item usage over time.
